(19) United States
(12) Patent Application Publication
(10) Pub. No.: US 2005/0010480 A1
(43) Pub. Date: Jan. 13, 2005

(54) Information providing system, information providing method, information providing device, and recording medium

(76) Inventors: Shogo Ishioka, Fukayasu-gun (JP); Yuji Odan, Tosu-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/030,125

(22) PCT Filed: May 25, 2001
(86) PCT No.: PCT/JP01/04386

(30) Foreign Application Priority Data
May 25, 2000 (JP) 2000-154893

(51) Int. Cl. G06F 17/60

(52) U.S. Cl. 705/26; 705/28

(57) ABSTRACT

The present invention provides an information service method for providing information about a circuit-board inspection service, circuit-board manufacturing service or the like to clients and dealers to support and facilitate transactions therebetween. The information service method comprises the steps of receiving a board-specification information defining a specification of a circuit board from the client, providing the received board-specification information to the dealers, receiving information about products providable from the dealers, and providing the received product information to the client. Thus, the information from each dealer can be provided to the client.

### TECHNICAL FIELD

The present invention relates to a system for providing a product and/or service information concerning a circuit board, a circuit-board inspection apparatus and any other related products or services to clients and dealers, so as to support and facilitate transactions therebetween.

### BACKGROUND ART

As computers and computer-related products have come into wide use, the demand for circuit boards and inspections has been increasing. Heretofore, a client intending to make a request for supplying a circuit-board inspection apparatus, a circuit-board inspection service, a circuit-board manufacturing service or the like has made contact with each dealer providing such services to get a desired service from them.

From a practical standpoint, it is difficult to evaluate which dealer can optimally meet the client's need for each circuit board to be requested, because of a great number of dealers providing various services associated with circuit boards. Particularly, respective circuit boards are different in wiring-pattern, components and others, and thereby it is required to prepare a dedicated jig and others for each of the circuit board to be manufactured and/or inspected. Thus, it is serious matter for a client to determine a suitable dealer for each circuit-board specification.

It is therefore an object of the present invention to provide an information service system, an information service method, an information service apparatus, an information acquisition apparatus and a recording medium capable of providing information about a circuit-board inspection, circuit-board manufacturing or the like to clients and dealers, so as to support and facilitate transactions therebetween

### DISCLOSURE OF THE INVENTION

According to a first aspect of the present invention, there is provided an information service system comprising a first computer available for a client intending to make a request for supplying an inspection apparatus used for a circuit board, a second computer available for a plurality of dealers including a first dealer intending to provide a circuit-board inspection apparatus or a component of circuit-board inspection apparatuses, and a third computer capable of communicating with the first computer and the second computer via a communication line, and adapted to receive the request from the first computer. Further, the third computer includes means for receiving a board-specification information defining a specification of the circuit board from the first computer, means for providing the received board-specification information to the second computer, means for receiving from the second computer a product information defining the circuit-board inspection apparatus or the component of circuit-board inspection apparatuses which is prepared for the board-specification information and is providable from the first dealer, and means for providing the received product information to the first computer.

According to a second aspect of the present invention, there is provided an information service apparatus capable of communicating via a communication line with a first computer available for a client intending to make a request for supplying an inspection apparatus used for a circuit board and a second computer available for a dealer intending to provide a circuit-board inspection apparatus or a component of circuit-board inspection apparatuses, wherein the information service apparatus is adapted to receive the request from the first computer. Further, the information service apparatus comprises means for receiving a board-specification information defining a specification of the circuit board from the first computer, means for providing the received board-specification information to the second computer, means for receiving from the second computer a product information defining the circuit-board inspection apparatus or the component of circuit-board inspection apparatuses which is prepared for the board-specification information and is providable from the dealer, and means for providing the received product information to the first computer.

According to a third aspect of the present invention, there is provided an information acquisition apparatus capable of communicating via a communication line with a first computer capable of communicating via a communication line with a second computer available for a dealer intending to provide a circuit-board inspection apparatus or a component of circuit-board inspection apparatuses, wherein the first computer is adapted to receive a request for supplying an inspection apparatus used for a circuit board. Further, the information acquisition apparatus comprises means for providing a request for supplying an inspection apparatus used for a circuit board and a board-specification information defining a specification of the circuit board to the first computer, and means for acquiring from the first computer a product information provided from the second computer to the first computer. The product information defines the circuit-board inspection apparatus or the component of circuit-board inspection apparatuses which is prepared for the board-specification information and is providable from the dealer.

According to a fourth aspect of the present invention, there is provided an information service apparatus capable of communicating via a communication line with a first computer capable of communicating via a communication line with a second computer available for a client intending to make a request for supplying an inspection apparatus used for a circuit board, wherein the first computer is adapted to receive the request from the second computer. The information service apparatus comprises means for acquiring from the first computer a board-specification information provided from the second computer to the first computer. The board-specification information defines a specification of the circuit board related to the request. The information service apparatus further includes means for providing to the first computer a product information defining the circuit-board inspection apparatus or the component of circuit-board inspection apparatuses which is prepared for the board-specification information.

According to a fifth aspect of the present invention, there is provided an information service method for providing information about an inspection apparatus to a client making a request for supplying an inspection apparatus used for a circuit board, comprising the steps of receiving from the client a board-specification information defining a specification of the circuit board, providing the received board-specification information to a dealer intending to provide a circuit-board inspection apparatus or a component of circuit-board inspection apparatuses, receiving a product information defining the circuit-board inspection apparatus or the component of circuit-board inspection apparatuses which is prepared for the board-specification information and is providable from the dealer, and providing the received product information to the client.

According to a sixth aspect of the present invention, there is provided a recording medium on which is recorded a program allowing a first computer to function as specific means, wherein the first computer is capable of communicating via a communication line with a second computer available for a client intending to make a request for supplying an inspection apparatus used for a circuit board and a third computer available for a dealer intending to provide a circuit-board inspection apparatus or a component of circuit-board inspection apparatuses, and the first computer is also adapted to receive the request from the second computer. The specific means includes means for receiving a board-specification information defining a specification of the circuit board from the second computer, means for providing the received board-specification information to the third computer, means for receiving from the third computer a product information defining the circuit-board inspection apparatus or the component of circuit-board inspection apparatuses which is prepared for the board-specification information and is providable from the dealer, and means for providing the received product information to the second computer.

According to a seventh aspect of the present invention, there is provided a recording medium on which is recorded a program allowing a first computer to function as specific means, wherein the first computer is capable of communicating via a communication line with a second computer capable of communicating via a communication line with a third computer available for a dealer intending to provide a circuit-board inspection apparatus or a component of circuit-board inspection apparatuses, and the second computer is adapted to receive a request for supplying an inspection apparatus used for a circuit board. The specific means including means for providing a request for supplying an inspection apparatus used for a circuit board and a board-specification information defining a specification of the circuit board to the second computer, and means for acquiring from the second computer a product information provided from the third computer to the second computer. The product information defines the circuit-board inspection apparatus or the component of circuit-board inspection apparatuses which is prepared for the board-specification information and is providable from the dealer.

According to an eighth aspect of the present invention, there is provided a recording medium on which is recorded a program allowing a first computer to function as specific means, wherein the first computer is capable of communicating via a communication line with a second computer capable of communicating via a communication line with a third computer available for a client intending to make a request for supplying an inspection apparatus used for a circuit board, and the second computer is adapted to receive the request from the third computer. The specific means includes means for acquiring from the second computer a board-specification information provided from the third computer to the second computer. The board-specification information defines a specification of the circuit board related to the request. The specific means further includes means for providing to the second computer a product information defining the circuit-board inspection apparatus or the component of circuit-board inspection apparatuses which is prepared for the board-specification information.

According to a ninth aspect of the present invention, there is provided an information service system comprising a first computer available for a client intending to make a request for a manufacturing service of a circuit board, a second computer available for a dealer intending to provide a circuit-board manufacturing service, and a third computer capable of communicating with the first computer and the second computer via a communication line, wherein the third computer is adapted to receive the request from the first computer. Further, the third computer includes means for receiving a board-specification information defining a specification of the circuit board from the first computer, means for providing the received board-specification information to the second computer, means for receiving from the second computer a product information related to the circuit board which is prepared for the board-specification information and is providable from the first dealer, and means for providing the received product information to the first computer.

According to a tenth aspect of the present invention, there is provided an information service apparatus capable of communicating via a communication line with a first computer available for a client intending to make a request for a manufacturing service of a circuit board and a second computer available for a dealer intending to provide a circuit-board manufacturing service, wherein the information service apparatus is adapted to receive the request from the first computer. Further, the information service apparatus comprises means for receiving a board-specification information defining a specification of the circuit board from the first computer, means for providing the received board-specification information to the second computer, means for receiving from the second computer a product information related to the circuit board which is prepared for the board-specification information and is providable from the dealer, and means for providing the received product information to the first computer.

According to a eleventh aspect of the present invention, there is provided an information acquisition apparatus capable of communicating via a communication line with a first computer capable of communicating via a communication line with a second computer available for a dealer intending to provide a circuit-board manufacturing service, wherein the first computer is adapted to receive a request for a manufacturing service of a circuit board. Further, the information acquisition apparatus comprises means for providing a request for a manufacturing service of a circuit board and a board-specification information defining a specification of the circuit board to the first computer, and means for acquiring from the first computer a product information provided from the second computer to the first computer. The product information is related to the circuit board which is prepared for the board-specification information and is providable from the dealer.

According to a twelfth aspect of the present invention, there is provided an information service apparatus capable of communicating via a communication line with a first computer capable of communicating via a communication line with a second computer available for a client intending to make a request for a manufacturing service of a circuit board, wherein the first computer is adapted to receive the request from the second computer. The information service apparatus comprises means for acquiring from the first computer a board-specification information provided from the second computer to the first computer. The board-specification information defines a specification of the circuit board related to the request. The information service apparatus further includes means for providing to the first computer a product information related to the circuit board which is prepared for the board-specification information.

According to a thirteenth aspect of the present invention, there is provided an information service method for providing information about a circuit-board manufacturing service to a client making a request for a manufacturing service of a circuit board, comprising the steps of receiving from the client a board-specification information defining a specification of the circuit board, providing the received board-specification information to a dealer intending to provide a circuit-board manufacturing service, receiving a product information related to the circuit board which is prepared for the board-specification information and is providable from the dealer, and providing the received product information to the client.

According to a fourteenth aspect of the present invention, there is provided a recording medium on which is recorded a program allowing a first computer to function as specific means, wherein the first computer is capable of communicating via a communication line with a second computer available for a client intending to make a request for a manufacturing service of a circuit board and a third computer available for a dealer intending to provide a circuit-board manufacturing service, and the first computer is also adapted to receive the request from the second computer. The specific means includes means for receiving a board-specification information defining a specification of the circuit board from the second computer, means for providing the received board-specification information to the third computer, means for receiving from the third computer a product information related to the circuit board which is prepared for the board-specification information and is providable from the dealer, and means for providing the received product information to the second computer.

According to a fifteenth aspect of the present invention, there is provided a recording medium on which is recorded a program allowing a first computer to function as specific means, wherein the first computer is capable of communicating via a communication line with a second computer capable of communicating via a communication line with a third computer available for a dealer intending to provide a circuit-board manufacturing service, and the second computer is adapted to receive a request for a manufacturing service of a circuit board. The specific means includes means for providing a request for a manufacturing service of a circuit board and a board-specification information defining a specification of the circuit board to the second computer, and means for acquiring from the second computer a product information provided from the third computer to the second computer. The product information is related to the circuit board which is prepared for the board-specification information and is providable from the dealer.

According to a sixteen aspect of the present invention, there is provided a recording medium on which is recorded a program allowing a first computer to function as specific means, wherein the first computer is capable of communicating via a communication line with a second computer capable of communicating via a communication line with a third computer available for a client intending to make a request for a manufacturing service of a circuit board, and the second computer is adapted to receive the request from the third computer. The specific means includes means for acquiring from the second computer a board-specification information provided from the third computer to the second computer. The board-specification information defining a specification of the circuit board related to the request. The specific means further includes means for providing to the second computer a product information related to the circuit board which is prepared for the board-specification information.

According to a seventeenth aspect of the present invention, there is provided an information service system comprising a first computer available for a client intending to make a request for an inspection service of a circuit board, a second computer available for a dealer intending to provide a circuit-board inspection service, and a third computer capable of communicating with the first computer and the second computer via a communication line, wherein the third computer is adapted to receive the request from the first computer. Further, the third computer includes means for receiving a board-specification information defining a specification of the circuit board from the first computer, means for providing the received board-specification information to the second computer, means for receiving from the second computer a service information defining the circuit-board inspection which is prepared for the board-specification information and is practicable by the first dealer, and means for providing the received service information to the first computer.

According to an eighteenth aspect of the present invention, there is provided an information service apparatus capable of communicating via a communication line with a first computer available for a client intending to make a request for an inspection service of a circuit board and a second computer available for a dealer intending to provide a circuit-board inspection service, wherein the information service apparatus is adapted to receive the request from the first computer. Further, the information service apparatus comprises means for receiving a board-specification information defining a specification of the circuit board from the first computer, means for providing the received board-specification information to the second computer, means for receiving from the second computer a service information defining the circuit-board inspection which is prepared for the board-specification information and is practicable by the dealer, and means for providing the received service information to the first computer.

According to a eighteenth aspect of the present invention, there is provided an information acquisition apparatus capable of communicating via a communication line with a first computer capable of communicating via a communication line with a second computer available for a dealer intending to provide a circuit-board inspection service, wherein the first computer is adapted to receive a request for an inspection service of a circuit board. Further, the information acquisition apparatus comprises means for providing a request for an inspection service of a circuit board and a board-specification information defining a specification of the circuit board to the first computer, and means for acquiring from the first computer a service information provided from the second computer to the first computer. The service information defines the circuit-board inspection which is prepared for the board-specification information and is practicable by the dealer.

According to a twentieth aspect of the present invention, there is provided an information service apparatus capable of communicating via a communication line with a first computer capable of communicating via a communication line with a second computer available for a client intending to make a request for an inspection service of a circuit board, wherein the first computer is adapted to receive the request from the second computer. Further, the information service apparatus comprises means for acquiring from the first computer a board-specification information provided from the second computer to the first computer. The board-specification information defines a specification of the circuit board related to the request. The information service apparatus further includes means for providing to the first computer a service information defining the circuit-board inspection which is prepared for the board-specification information.

According to a twenty-first aspect of the present invention, there is provided an information service method for providing information about a circuit-board inspection service to a client making a request for an inspection service of a circuit board, comprising the steps of receiving from the client a board-specification information defining a specification of the circuit board, providing the received board-specification information to a dealer intending to provide a circuit-board inspection service, receiving a service information defining the circuit-board inspection which is practicable by the dealer; and providing the received service information to the client.

According to a twenty-second aspect of the present invention, there is provided a recording medium on which is recorded a program allowing a first computer to function as specific means, wherein the first computer is capable of communicating via a communication line with a second computer available for a client intending to make a request for an inspection service of a circuit board and a third computer available for a dealer intending to provide a circuit-board inspection service, and the first computer is also adapted to receive the request from the second computer. The specific means includes means for receiving a board-specification information defining a specification of the circuit board from the second computer, means for providing the received board-specification information to the third computer, means for receiving from the third computer a service information defining the circuit-board inspection which is prepared for the board-specification information and is practicable by the dealer, and means for providing the received service information to the second computer.

According to a twenty-three aspect of the present invention, there is provided a recording medium on which is recorded a program allowing a first computer to function as specific means, wherein the first computer is capable of communicating via a communication line with a second computer capable of communicating via a communication line with a third computer available for a dealer intending to provide a circuit-board inspection service, and the second computer is adapted to receive a request for an inspection service of a circuit board. The specific means includes means for providing a request for an inspection service of a circuit board and a board-specification information defining a specification of the circuit board to the second computer, and means for acquiring from the second computer a service information provided from the third computer to the second computer. The service information defines the circuit-board inspection which is prepared for the board-specification information and is practicable by the dealer.

According to a twenty-fourth aspect of the present invention, there is provided a recording medium on which is recorded a program allowing a first computer to function as specific means, wherein the first computer is capable of communicating via a communication line with a second computer capable of communicating via a communication line with a third computer available for a client intending to make a request for an inspection service of a circuit board, and the second computer is adapted to receive the request from the third computer. The specific means includes means for acquiring from the second computer a board-specification information provided from the third computer to the second computer. The board-specification information defines a specification of the circuit board related to the request. The specific means further includes means for providing to the second computer a service information defining the circuit-board inspection which is prepared for the board-specification information.

According to a twenty-fifth aspect of the present invention, there is provided an information service apparatus capable of communicating with a first computer available for a client intending to make a request for supplying an inspection apparatus used for a circuit board, wherein the information service apparatus is adapted to receive the request from the first computer. Further, the information service apparatus comprises means for receiving a board-specification information defining a specification of the circuit board from the first computer, and means for providing to the first computer a product information collected from a dealer intending to provide a circuit-board inspection apparatus or a component of circuit-board inspection apparatuses. The product information defines the circuit-board inspection apparatus or the component of circuit-board inspection apparatuses which is prepared for the received board-specification information.

According to a twenty-sixth aspect of the present invention, there is provided an information service apparatus capable of communicating with a first computer available for a client intending to make a request for a manufacturing service of a circuit board, wherein the information service apparatus is adapted to receive the request from the first computer. Further, the information service apparatus comprises means for receiving a board-specification information defining a specification of the circuit board from the first computer, and means for providing to the first computer a product information collected from a dealer intending to provide a circuit-board manufacturing service. The product information is related to the circuit board which is prepared for the received board-specification information.

According to a twenty-seventh aspect of the present invention, there is provided an information service apparatus capable of communicating with a first computer available for a client intending to make a request for supplying an inspection service of a circuit board, wherein the information service apparatus is adapted to receive the request from the first computer. Further, the information service apparatus comprises means for receiving a board-specification information defining a specification of the circuit board from the first computer, and means for providing to the first computer a service information collected from a dealer intending to provide a circuit-board inspection service. The product information defines the circuit-board inspection which is prepared for the received board-specification information and is practicable by the dealer.

### BRIEF DESCRIPTION OF THE DRAWINGS

FIG. 1 is a schematic diagram of an information service system A according to one embodiment of the present invention;

FIG. 2 is a schematic flowchart showing an entire processing in the information service system A;

FIG. 3 is a flowchart showing a processing executed by a computer 2 in requesting an information service;

FIG. 4 is an exemplary diagram of a service-select screen page provided by a system server 1;

FIG. 5 is an exemplary diagram of an information-input screen page displayed when either one of “Inspection Apparatus Service”, “Inspection Service” and “Circuit Board Service” is selected in the screen page shown in FIG. 4;

FIG. 6 is an exemplary diagram of an information-input screen page displayed when “User Registration” is selected in the screen page shown in FIG. 4;

FIG. 7 is a flowchart showing a processing for requesting an information service request and receiving a user registration in the system server 1;

FIG. 8 is an exemplary diagram of a user management table;

FIG. 9 is an exemplary diagram of a screen page for notifying a receipt number;

FIG. 10 is an exemplary diagram of a request management table;

FIG. 11 is a flowchart showing a processing executed by a computer 3 in using a checking service of a request status;

FIG. 12 is an exemplary diagram showing an image of the request status displayed on the computer 3;

FIG. 13 is a flowchart showing a processing executed by the computer 2 in giving out an order of a product or the like;

FIG. 14 is an exemplary diagram of an information-input screen page displayed when “Order” is selected in the screen page shown in FIG. 4;

FIG. 15 is a flowchart showing a processing executed by the computer 2 in requesting an after-sale service;

FIG. 16 is an exemplary diagram of an information-input screen page displayed when “After-sale service” is selected in the screen page shown in FIG. 4;

FIG. 17 is a flowchart showing a processing executed by the system server 1 in receiving an instruction of an order; and

FIG. 18 is a flowchart showing a processing executed by the system server 1 in receiving an instruction of an after-sale service.

### BEST MODE FOR CARRYING OUT THE INVENTION

A preferred embodiment of the present invention will now be described with reference to the drawings.

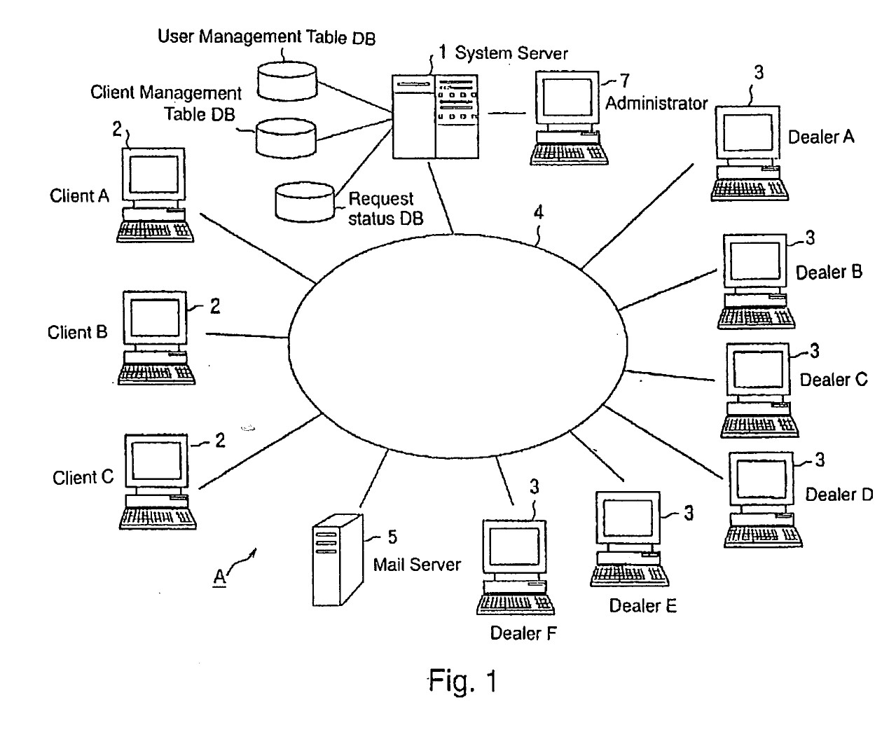

FIG. 1 is a schematic diagram of an information service system A according to one embodiment of the present invention.

The information service system A comprises a system server 1 for managing information on this system, a plurality of computers 2 which are used by each client (clients A to C) intending to make a request for supplying information about a circuit board or the like, a plurality of computers 3 which are used by each dealer (dealers A to F) intending to provide a service associated with a circuit board, a network 4 connected with the system server 1 and the computers 2 and 3 to provide a communication environment such as the Internet, and a mail server 5 for managing E-male on the network 4.

The system server 1 acts as a server computer configured to communicate with each of the computers 2 and 3 via the network 4. The system server 1 executes various processing for receiving requests, providing information and others. The system server 1 further includes a user-management table database (hereinafter, “database” is referred to as “DB”) for recording information about system users (including both clients and dealers) to function as a dealer DB or a client DB, a request management table DB, and a request status DB for recording information about a request status.

Furthermore, the system server 1 is connected to a computer 7 used by a system administrator, and the system administrator can manage and handle the information recorded in the system server 1 through the computer 7.

Each of the computers 2 and 3 is a general-purpose computer which includes an input device such as a keyboard, mouse or the like and a display, and can get connection to the network. Preferably, each of the computers 2 and 3 includes a conventional document-processing program, an Internet browser, an E-mail management program or the like. In this embodiment, while the computers used by the clients are distinguished from those used by the dealers simply for the purpose of clarifying the description, the clients may be substituted with the dealers, and the dealers may be substituted with the clients. Further, while the information service system A includes three of the computers 2, and six of the computers 3, it is apparent that such number will be selectable depending on the number of system users.

Further, the dealer in this embodiment may include a manufacturer of a circuit-board inspection apparatus, each manufacturer of various components of an inspection apparatus, such as an inspection jig, a tester, a sensor and a press machine, a manufacturer of a circuit board, a manufacturer of a prototype circuit board, a manufacturer of a board material of circuit boards, distributors of such products, an inspection-service agent taking a turn of inspecting circuit boards, and a maintenance-service agent for providing an after-sale service.

The mail server 5 acts as a server computer for supporting various communications, such as for giving a notification, providing information, between the system server 1 and the computers 2, 3 through E-mail. While only one mail server is shown in the figure, any mail servers of providers associated with each of the clients and dealers or the administrator may be applied to this system, as well as any mail server on the Internet.

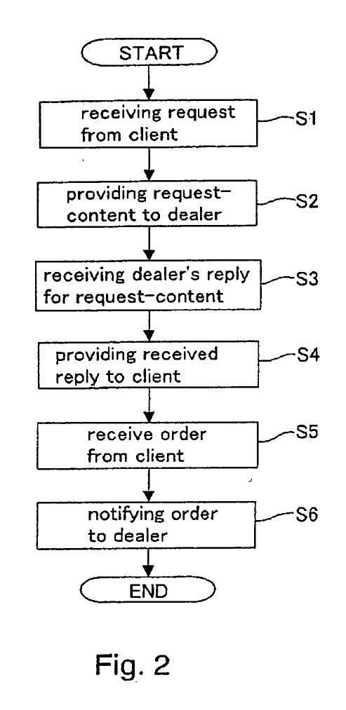

With reference to FIG. 2, an entire flow between a request and an order for a circuit-board manufacturing service, circuit-board inspection service or the like, which is achieved by using the information service system A will be described below.

In the step S1, a request from a client is received. In making the request, the client is required to specify or designate the specification of a desired circuit board or the content of a desired service.

In the step S2, the request content is provided to each of the dealers. This allows each of the dealers to know a demand for their business.

In the step S3, some replies to the request content from the dealers are received. The dealers can create an opportunity of new transactions by providing information about their available products and services in response to the request content.

In the step S4, the received replies are provided to the client. The client can select one optimal dealer meeting his/her need according to the obtained information from each of the dealers.

In the step S5, if an order is given out from the client, the order is received.

In the step S6, the order is provided to the dealer designated by the order. Thus, the client and the dealer can make a deal with mutual consent.

By performing such a scheme and steps, the information service system A according to this embodiment can provide various related information to a client having a plan or under review of making a request for a purchase of a circuit-board inspection apparatus (including of components thereof, a circuit-board inspection service, or a circuit-board manufacturing service. At the same time, the information about presence of such a client's need is provided to each of the dealers.

Furthermore, the information service system A handles order and order-receiving of products, services or their after-sale services between a client and each dealer.

Each processing will be described in detail below.

<Request for Information Service etc.>

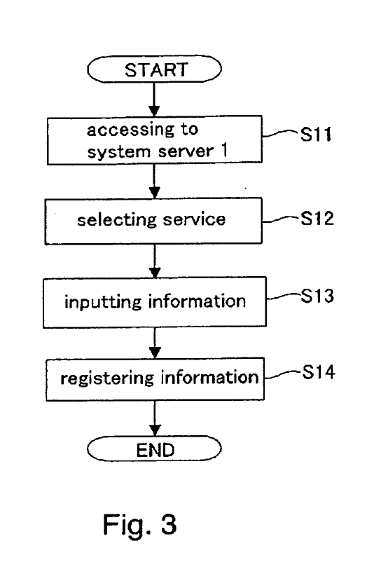

With respect to a information service about circuit boards provided by the information service system A, the steps performed by a client to make a request for the information service will be described. FIG. 3 is a flowchart showing a processing executed by the computer 2 in making a request for the information service.

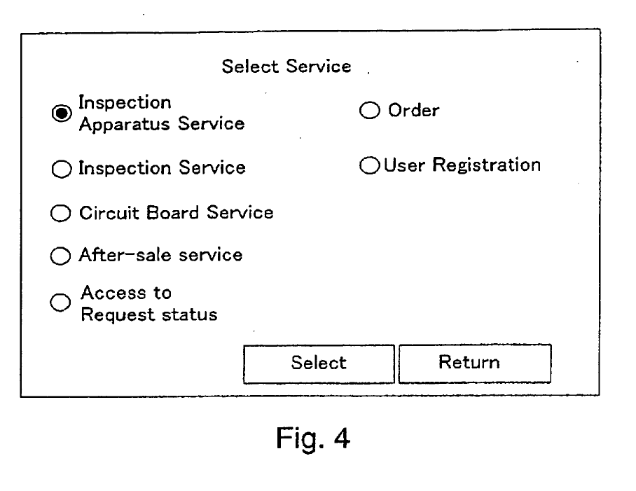

In the step S11, through the computer 2, the client accesses to a home page (site) provided on the Internet by the system server 1 to display a screen page for selecting a desired service or a service-select screen page. FIG. 4 is an exemplary diagram showing of the service-select screen page provided by the system server 1.

In FIG. 4, selecting the “Inspection Apparatus Service” means to make a request for a product information service about an inspection apparatus for circuit boards. This information includes any product information about not only an inspection apparatus itself but also components of the inspection apparatus. The client may use this service in order to purchase an inspection apparatus and/or an associated component for inspecting circuit boards owned by the client from a suitable dealer. Selecting the “Inspection Service” means to make a request for an information service about a circuit-board inspection service. The client may use this service to ask an inspection service of circuit board boards owned by the client to a suitable dealer. Selecting the “Circuit Board Service” means to make a request for a product information service about a circuit board itself. The client may use this service to ask a manufacturing service of circuit boards according to a specification defined by the client to a suitable dealer.

Selecting the “After-sale service” means to make a request for an after-sale service of the product or service purchased or used through the information service system A. The “Access to Request Status” is used by the dealers to check a request status.

Selecting the “Order” means that the client used the information service makes an order of the product or the services. The “User Registration” is used to register the clients, the dealers and any other users of this system.

Now, each step in the “Inspection Apparatus Service”, “Inspection Service”, “Circuit Board Service” and “User Registration” will be described.

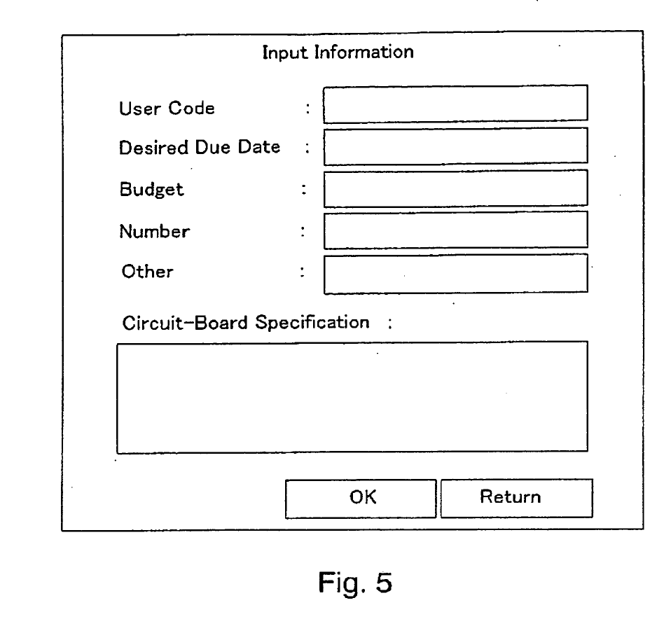

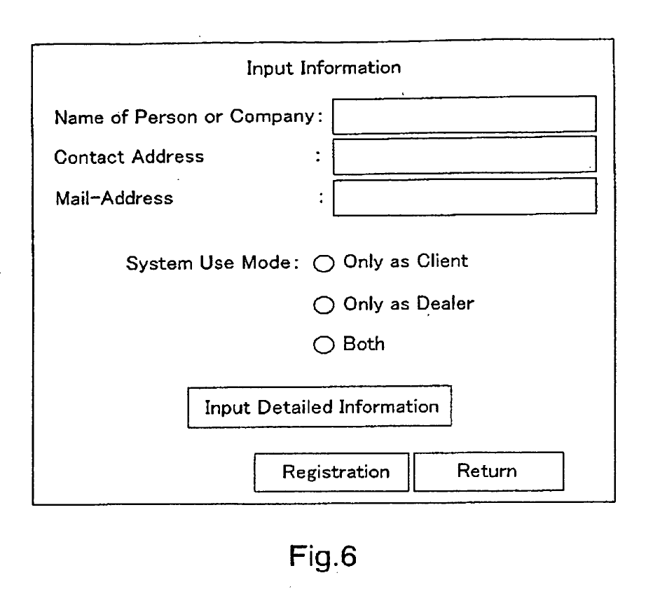

Returning to FIG. 3, in the step S12, the client selects one of the services. The service selection is performed by checking a radio-button provided in each field and pushing a “Select” button. When selecting either one of the “Inspection Apparatus Service”, “Inspection Service” and “Circuit Board Service”, an information-input screen page shown in FIG. 5 will be displayed. When selecting the “User Registration”, an information-input screen page shown in FIG. 6 will be displayed. Then, in the step 13, required information will be input.

FIG. 5 shows an example of an information-input screen page to be displayed when either one of the “Inspection Apparatus Service”, “Inspection Service” and “Circuit Board Service” is selected. In FIG. 5, a code given individually to each user after a user registration step is input into a “User Code” field. When making an order of the inspection apparatus service, the inspection service or the circuit board service, the user is input a desired delivery date of the product or a desired date of completing the inspection into a “Desired Due Date” field. The user also inputs an amount of payable money for the cost of the product or the inspection service into a “Budget” field. The number of the inspection apparatuses or the circuit boards to be purchased by the client, or the number of the circuit boards subject to the request for the inspection service is input into a “Volume” field.

In an “Other” field, any other request items are input by the client. For example, such items may include designation of target dealers, limitation of target apparatus by defining functions thereof, immediacy for supplying information, specific format or item of information to be provided, designation of the category of inspection (short-circuit, breakage, chipping or the like), confidentiality or anonymous, deadline for supplying information, and limitation to prototype of circuit boards.

Information about the specification of a circuit board to be requested to an appointed dealer (hereafter referred to as “board-specification information”) is input in a “Circuit Board Specification” field. For example, this information includes any information for identifying the circuit board requested by the client, such as a wiring/design diagram of the circuit board, designation of a bare board or packaged board, and the type and application of the circuit board. Further, such information may be input directly in the “Circuit Board Specification” field, and a pre-created electronic data file may be attached thereto.

After the completion of the input of the above information, an “OK” button is pushed to transmit the input information to the system server 1, and the transmitted information will be registered (the step S14). When a “Return” key is pushed, a previous screen page is displayed again without transmitting the information.

FIG. 6 shows an example of an information-input screen page displayed when a “User Registration” is selected. In this embodiment, any clients and dealers (users) using the information service system A is essentially required to go through the procedure of the user registration.

In FIG. 6, in the “Name of Person or Company” field, the name of a user or a company is input. A contact address of a user, such as street address, telephone number, or FAX number is input in a “Contact Address” field. An E-male address of a user is input in a “Mail Address” field. In a “System Use Mode” field, one of radio buttons is checked by selecting either one of “Only as Client” for using this system only as a client, “Only as Dealer” for using only as a dealer, or “Both” for using both as a client and a dealer. An “Input Detailed Information” button is provided for inputting detailed information of a user. When pushing this button, another screen page (not shown) is displayed for inputting detailed information. For example, such information includes business size and dealing products of each dealer, or facilities of a user.

After inputting the above information, the input information is transmitted to the system server 1 by pushing a “Registration” button, and the transmitted information will be registered (the step S14). If the registration is accepted, a user code is given through E-mail or the like from the system server 1 later.

<Request for Information Service and Receipt of User Registration>

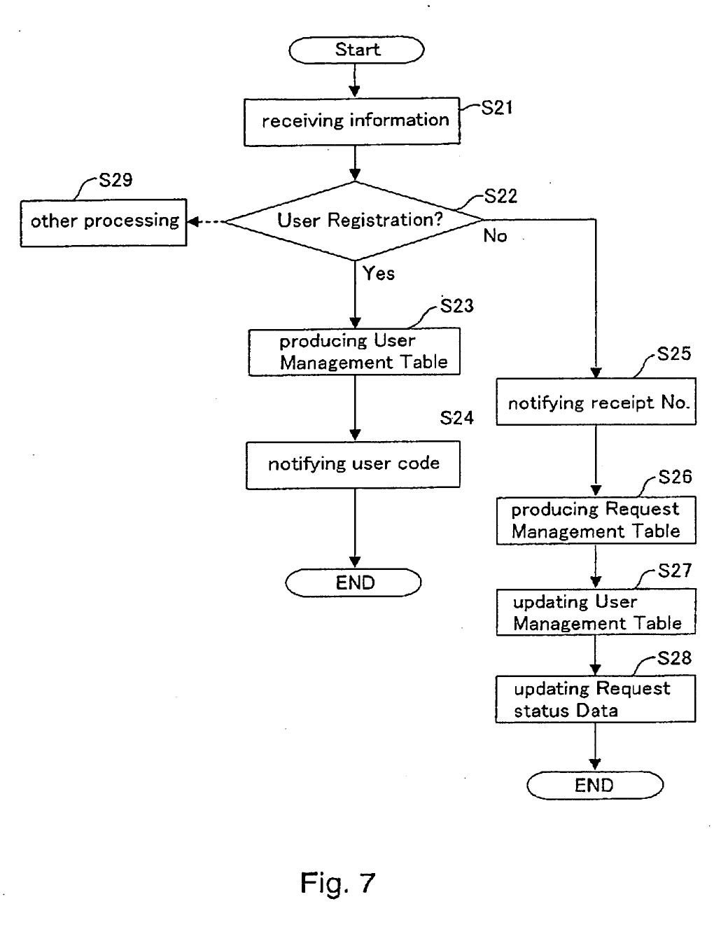

A processing in the system server 1 corresponding to the processing in the computer 2 described in the above <Request for Information Service etc.> will be described. FIG. 7 is a flowchart showing a processing in the system server 1 for receiving a request for an information service and a user registration. In FIG. 7 shows a processing in case that either one of the “Inspection Apparatus Service”, “Inspection Service”, “Circuit Board Service” and “User Registration” of the screen page of FIG. 4 is selected in the computer 2.

In the step S21, information transmitted from the computer 2 is received.

In the step S22, it is judged which service is related to the received information. For the information relates to the “User Registration”, it is judged as the user registration, and the process goes to the step S23. When the information is relates to the “Inspection Apparatus Service”, “Inspection Service” or “Circuit Board Service”, such a service is distinguished, and the process goes to the step S25. If not, the process goes to the step S29 to execute another processing.

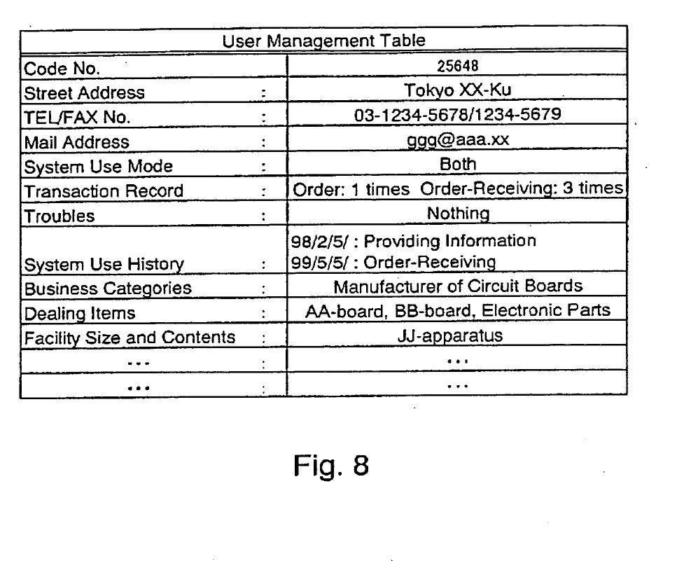

In the step S23, a user management table is produced for a user made an application for the user registration. FIG. 8 is an exemplary diagram showing the user management table.

In FIG. 8, the left column shows information-items to be managed, and the right column shows an example of information corresponding to each item.

A code No. automatically issued for each user from the system server 1 is stored in a “Code No.” field. The information input by the user in the screen page of FIG. 6 is input in each of a “Street Address” field, “TEL/FAX No.” field, “Mail Address” field and “System Use Mode” field. The information input by pushing the “Input Detailed Information” button and the information produced by the system server 1 is input in each field below the above fields.

The information about the number of order and order-receiving by use of this system is stored in a “Transaction Record” field. If there has been a trouble in transactions by use of this system, information about the content of such trouble is stored in a “Troubles” field. Information about a use history of the system is stored in a “System Use History” field. Information about a business category of the user is input in a “Business Categories” field. Information about product items and service categories dealt by the user is input in a “Dealing Items” field. Each use's information about facility contents, business size, product manufacturing capacity, and service ability for inspection service etc. is stored in a “Facility-Size and Contents” field.

The produced user management table including the above information can be used as a reference for selecting a dealer and requesting to provide a product information or the like by the system administrator. Further, by providing all or a part of such information to a dealer, the dealer can provide a product information or a service information about an inspection service suitable for a client. The produced user management table is stored in a user management table DB. Thus, the user is registered in the system and each of the information is stored in association with each other.

In the step S24, the issued code is notified through E-mail or the like to the computer 2 through which the application for the user registration has been made, and then the processing is terminated.

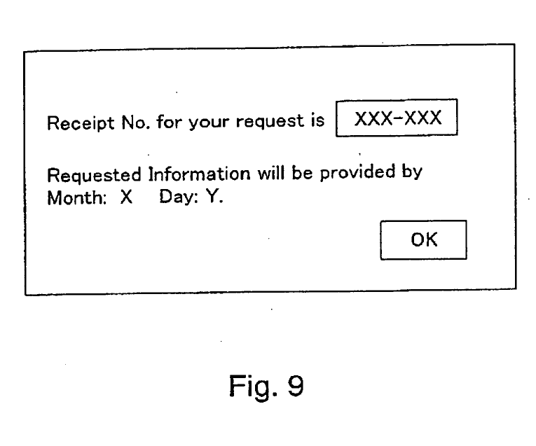

Then, in the step S25, the system server 1 issues a receipt No., and notifies it to the client. The receipt No. is issued for each request. In this embodiment, this receipt No. is also used in the subsequent processing, for example, in providing information, making an order, and providing an after-sale services. While the receipt No. can be notified through E-mail or the like to the computer 2 of the client, it is also possible to notify the receipt No. in real time by displaying the screen page shown in FIG. 9 on the computer 2 of the client,

In the step S26, a request management table is produced. The request management table is produced for each request to manage the requests individually. When a request for an information service is made from a client, the request management table is produced, and corresponding information to the request is stored in the table.

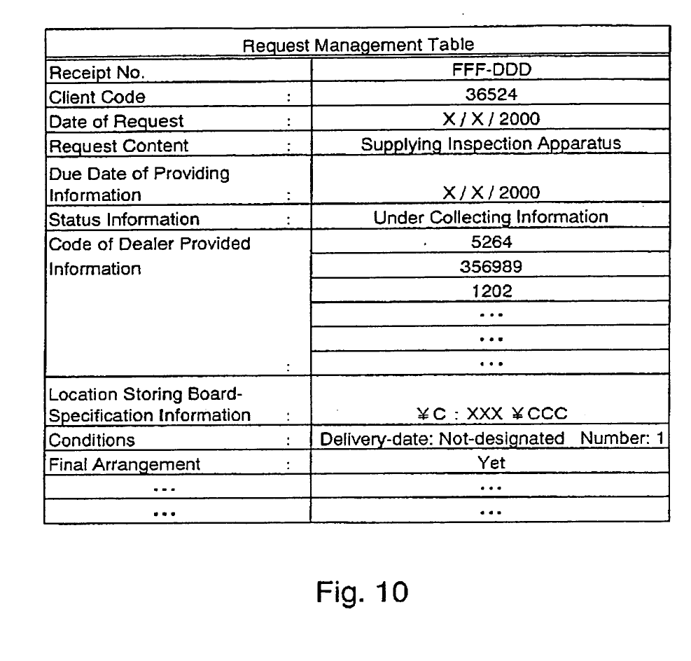

FIG. 10 is an exemplary diagram showing a request management table. In FIG. 10, information items to be managed are shown in a left column, and each information example corresponding to each item is shown in a right column.

The receipt No. issued automatically for each request by the system server 1 is stored in a “Receipt No.” field. The code No. of the client is stored in a “Client Code” field. The date when the request has been received is stored in a “Date of Request” field.

The category of the received service, such as either one of the “Inspection Apparatus Service”, “Inspection Service” and “Circuit Board Service” in this embodiment, is stored in a “Request Contents” field. A due date of providing information to the client is stored in a “Due Date of Providing Information” field. This date may be determined by a request of the client (input in the “Other” field in the screen page of FIG. 5). Alternatively, it is possible to automatically arrange on the side of the system server 1 with a given days after the request is received. In this embodiment, a due date of providing information is notified in conjunction with the notification of the receipt No. in FIG. 9.

The information about the status for the request is stored in a “Status Information” field. For example, a wait status for information from dealers is displayed as “Under Collecting Information” is displayed. After providing the collected information from dealers to the client, “Completion of Providing Information” is displayed. A user code of the dealer who has provided the information for the request is stored in a “Code of Dealer Provided Information” field.

An identifier indicating a location storing a material data of the board-specification information provided by the client is stored in a “Location Storing Board-Specification information” field. Since the data volume of the board-specification information can be large, the data is stored in a DB (not shown) instead of storing it in the request management table in this embodiment. However, it is apparent that the board-specification information may be stored in this table.

Information about each conditions designated by the client is stored in a “Conditions” field. For example, the condition includes a delivery date or the number of the product. A final arrangement for the request, such as information about achievement of order or ending only with providing information is stored in a “Final Arrangement” field.

The produced request management table including the above information can be used by the system administrator as a reference for selecting a specific dealer and requesting to provide a product information or the like. The produced request management table is stored in a request management table DB. Thus, each request is registered in the system and the board-specification information and other associated information in the request are stored in association with each other.

Returning to FIG. 7, in the step S27, the user management table of the client making the requests is retrieved from the user management table DB to update the information according to changes caused by this request. For example, the “System Use History” and other are updated.

In the step S28, a request status data is updated. This request status data provides a status of client's requests to dealers, and is stored in a request status DB. After updating, the processing is terminated.

<Request for Providing Information to Dealer>

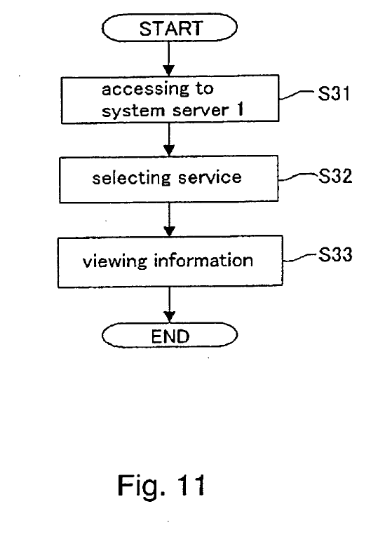

In this embodiment, each dealer can receive information about current requests (request status) from the system server 1. FIG. 11 is a flowchart showing a processing executed in the computer 3 for a request status service.

In the step S31, through the computer 3, the dealer accesses to the home page (site) provided on the Internet by the system server 1 to display the service-select screen page shown in FIG. 4.

In the step S32, one of the services is selected. Given that the radio button of the “Access to Request Status” is checked and the “Select” button is pushed herein.

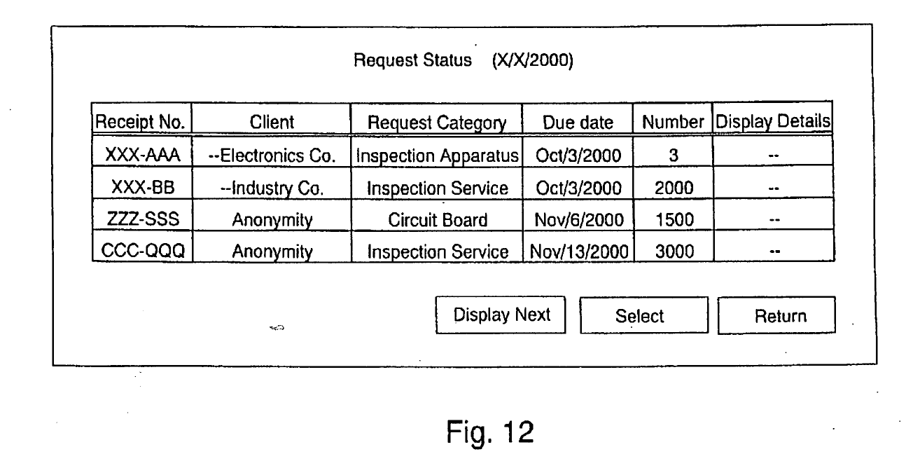

In the step S33, the request status is viewed. In the step S32, when the “Access to Request Status” is selected, the system server 1 provides the information about the request status stored in the request status DB to the computer 3. FIG. 12 is an exemplary diagram showing a screen page of the request status which is provided from the system server 1 and displayed on the computer 3. The request status is displayed as a list of each request.

In FIG. 12, the receipt No. of each request is displayed in a “Receipt No.” field. The client name of each request is displayed in a “Client” field. When the client requests anonymity, the name is withheld the category of the request is indicated in a “Request Categories” field, and either one of the “Inspection Apparatus Service (Inspection Apparatus)”, “Inspection Service” and “Circuit-Board Manufacturing service (Circuit Board)” is displayed.

A delivery date of the product, the completion date of the inspection or the like designated by the client is displayed in a “Due Date” field. The number of the products or the number of circuit boards to be inspected is displayed in a “Number” field. A check box for each request is displayed in a “Display Details” field. When this check box is checked and then a “Select” button is pushed, all or a part of the detailed request information including the board-specification information related to the request, for example, the information stored in the above request management table of the request or the information stored in the user management table of the client is displayed.

A “Display Next” button is provided to display a list of the other requests, and a “Return” button is provided to return to the previous screen page.

After viewing, the processing is terminated.

Each dealer can get information about requests and get business opportunities for their products and services by viewing of this request status.

In this embodiment, the request status is displayed on the home page of the system server 1 to provide the request status, the board-specification information and the like to each dealer. However, a notification for informing new request may be provided to a dealer designated by the client or selected by the system administrator for each request content, for example, a dealer providing a product or an inspection service suitable for the board specification information, with the board specification information and all or a part of the information stored in the above request management table or user management table related to the request, through E-mail, FAX or the like.

<Providing Information as Response to Request>

After viewing the above request status, each dealer can provide to the system server 1 a product information or service-information about a product or inspection service providable from the dealer for the board-specification information related to the request. The dealer can also provide information about product cost, the available number of products, delivery date or inspection service cost of, days necessary for the inspection and the like.

Such information can be provided from the computer 3 to the system server 1 through E-mail, FAX or the like. In this process, the receipt No. can identify the relationship between such information and the request.

The system server 1 received the information from each dealer, the system server 1 brings the information together, and provides a set of the information to the computer 2 used by the client through E-mail, or FAX or the like owned by the client. In this case, the information may be selected by the system depending on the client's need, the board-specification information or the like, and then provided to the client.

The client received the provided information can select an optimal dealer meeting with his/her demand, such as the content or cost of the product or the circuit-board inspection service to order or request the product or the circuit-board inspection service.

In this manner, the information service system A can provide the information necessary for both clients and dealers, that is, each information about a circuit-board manufacturing service, an inspection apparatus, a circuit-board inspection service or the like to the clients and the dealers to support and facilitate transactions therebetween.

<Order to Dealer>

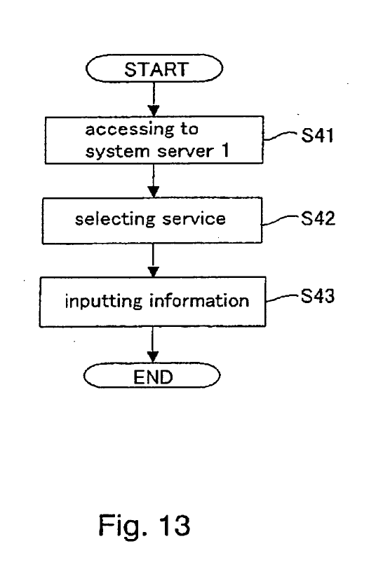

In the information service system A, each client can make an order or request for a product and/or an inspection service to a dealer selected according to the information provided from the system server 1. FIG. 13 is a flowchart showing a processing executed by the computer 2 in making an ordering of a product or the like.

In the step S41, through the computer 2, the client (orderer) accesses to the home page (site) provided on the Internet by the system server 1 to display the service-select screen page of shown in FIG. 4.

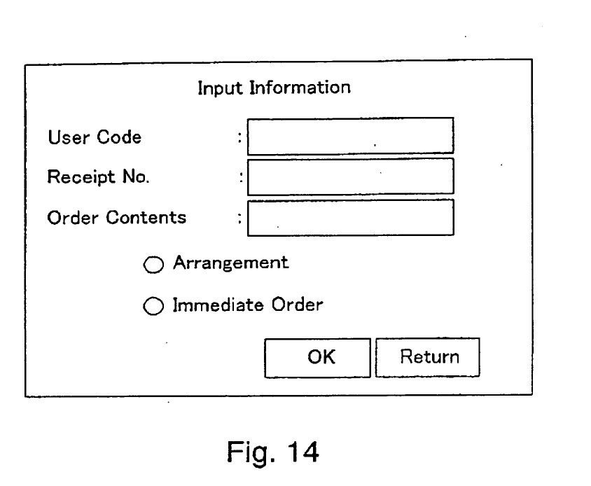

In the step S42, one of the services is selected. Given that the radio button of the “Order” is checked and the “Select” button is pushed herein. Then, an information-input screen page shown in FIG. 14 is displayed on the computer 2, and the client goes to the step S43.

In the step S43, information is input into the displayed information-input screen page. FIG. 14 is an exemplary diagram showing the information-input screen page displayed when selecting the “Order” in the screen page of FIG. 4.

In FIG. 14, the user-code of the client is input in a “User-Code” field. The receipt No. (FIG. 9) issued when the system server 1 was requested to collect information from a dealer is input in a “Receipt No.” field. The client inputs a dealer's name, a product's name or a service category such as an inspection service in an “Order Contents” field.

For making the order immediately, an “Immediate Order” radio button is checked. For requesting an arrangement before a final order, an “Arrangement” radio-button is checked. When an “OK” button is pushed, the input information is transmitted to the system server 1. When a “Return” button is pushed, the previous screen page is displayed again. Then, the processing is terminated.

While the order in this embodiment has been made through the information service system A, it is apparent that the client may make an order directly to each dealer.

<Receipt of Order>

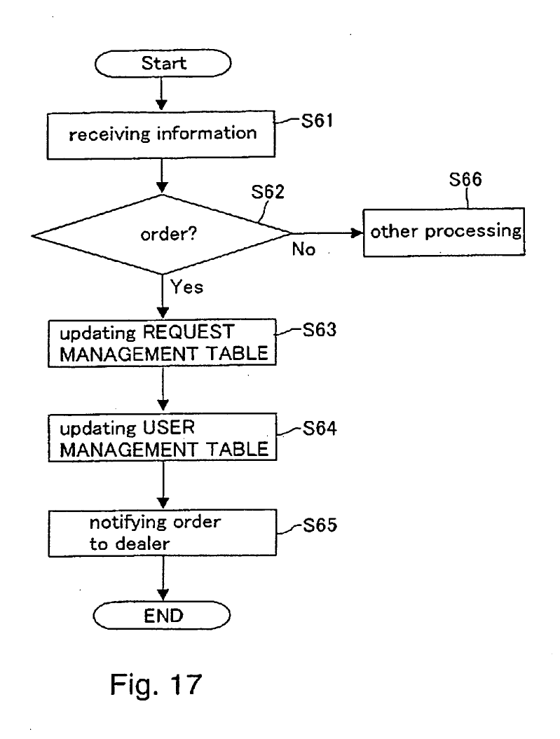

A corresponding processing in the system server 1 to the processing in the computer 2 described in the above <Order to Dealer> will be described. FIG. 17 is a flowchart showing a processing in the system server 1 for the above order from the client.

In the step S61, the information transmitted from the computer 2 is received.

In the step S62, it is judged which service is related to the received information. When the information is relates to “Order”, the process goes to the step S63. If not, the process goes to the step S66, and the other processing are executed.

In the step S63, the request management table of the request related to the order is retrieved from the request management table DB to update the information according to changes caused by this order. For example, the “Status Information” field, “Final Arrangement” field and the like will be updated.

In the step S64, the user management tables of the client who made the order and the dealer who will receive the order are retrieved from the user management table DB. The information is updated according to changes caused by this order. For example, the “System Use History” field, “Transaction Record” and the like will be updated.

In the step S65, the order is notified to the appointed dealer through E-mail or the like. Thus, the dealer receiving the order can make a deal with the client. Then, the processing is terminated.

<Requesting of After-sale Service>

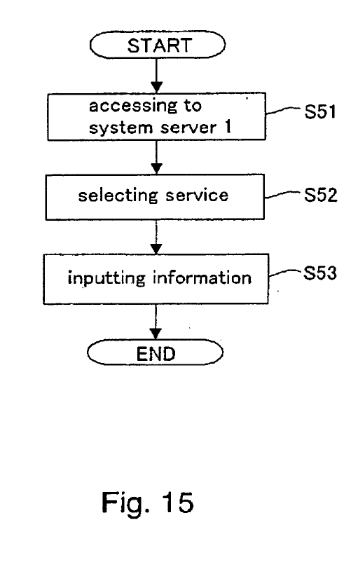

By using the information service system A, each client can also make a request for an after-sale service of the product or the circuit-board inspection which was made the order from the client to the dealer. FIG. 15 is a flowchart showing a processing executed by the computer 2 in making a request for an after-sale service.

In the step S51, through the computer 2, the client accesses to the home page (site) provided on the Internet by the system server 1 to display the service-select screen page of shown in FIG. 4.

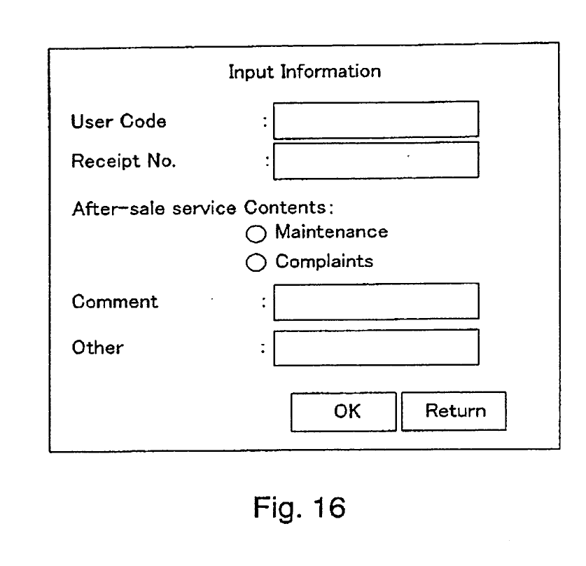

In the step S52, one of the services is selected. Given that the “After-sale service” radio button is checked and the “Select” button is pushed. Then, an information-input screen page shown in FIG. 16 is displayed on the computer 2, and the process goes to the step S43.

In the step S43, information is input into the displayed information-input screen page. FIG. 16 is an exemplary diagram showing the information-input screen page displayed when selecting the “After-sale service” on the screen page of FIG. 4.

In FIG. 16, the user code of the client is input in a “User-Code” field. The receipt No. (FIG. 9) issued when the system server 1 was requested to collect information from the dealer is input in a “Receipt No.” field. In an “After-sale service Contents” field, the content of an after-sale service can be designated by checking the radio-buttons. For example, for replacing consumable parts, routine check or the like, the “Maintenance” is checked. For complaints about a defective product, a defective inspection service or the like, the “Complaints” is checked.

A detailed content of an after-sale service is input in a “Comment” field. For example, the information to be input includes the need for replacing parts of the purchased inspection apparatus, the need for inspecting the purchased inspection apparatus, or the complaint of a defect of the purchased inspection apparatus. Information about any message to the system administrator, designation of a dealer of the after-sale service dealer, designation of a date of the after-sale service or the like is input in an “Other” field.

After inputting, when an “OK” button is pushed, the input information is transmitted to the system server 1. When an “Return” button is pushed, the previous screen page is displayed again.

While the after-sale service in this embodiment has been requested through the information service system A, it is apparent that the client may make a request for the after-sale service directly to each dealer.

<Receipt of After-sale Service>

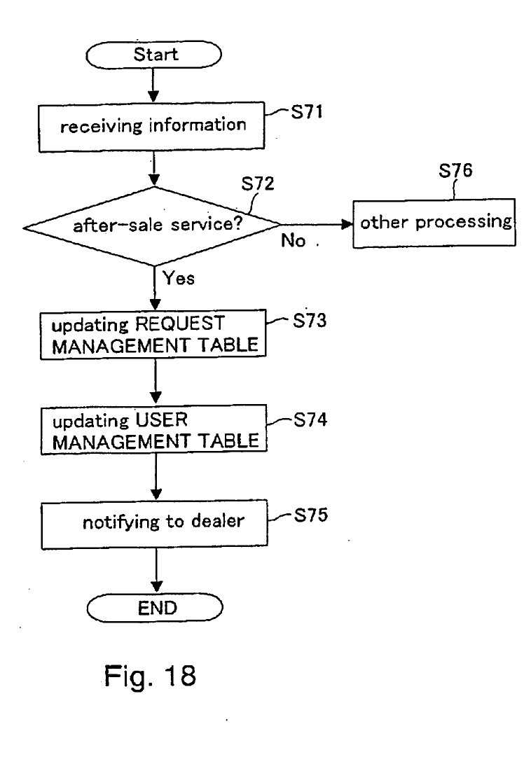

A corresponding processing in the system server 1 to the processing in the computer 2 described in the above <Request for After-sale service> will be described. FIG. 18 is a flowchart showing a processing executed by the system server 1 in making a request for an after-sale service from a client.

In the step S71, the information transmitted from the computer 2 is received.

In the step S72, it is judged which service is relates to the received information. For the information relates to the “After-sale service”, the process goes to the step S73. If not, the process goes to the step S76 and other processing are executed.

In the step S73, the request management table of the request relating to the order is retrieved from the request management table DB to update the request management table according to changes caused by this order. For example, the “Status Information”, “Final Arrangement” and the like will be updated.

In the step S74, the user management tables of the client who made the order and the dealer who will receive the order are retrieved from the user management table DB to update the user management tables according to changes caused by this order. For example, the “System Use History” field, the “Troubles” field and the like will be updated.

In the step S65, the request for an after-sale service is notified to the dealer who sold the product or provided the circuit-board inspection service or a specialized dealer providing an after-sale service through E-mail or the like. Thus, the dealer received the request can support speedily. Then, the processing is terminated.

As above, while the present invention has been described in conjunction with the preferred embodiment, it is apparent that the present invention can be achieved by providing to a computer a recording medium on which is recorded a program code of software realizing functions of the aforementioned embodiment and by making the computer retrieve and execute the program code stored in the recording medium. In this case, it is intended that such recording medium is encompassed within the scope of the present invention.

Industrial Applicability

As described above, the present invention can provide information about a circuit-board inspection, circuit-board manufacturing or the like to clients and dealers to support and facilitate transactions therebetween.

1. An information service system comprising:
a first computer available for a client intending to make a request for supplying an inspection apparatus used for a circuit board;
a second computer available for a plurality of dealers including a first dealer intending to provide a circuit-board inspection apparatus or a component of circuit-board inspection apparatuses; and
a third computer capable of communicating with said first computer and said second computer via a communication line, said third computer being adapted to receive said request from said first computer, wherein
said third computer including:
means for receiving a board-specification information defining a specification of said circuit board from said first computer;
means for providing said received board-specification information to said second computer;
means for receiving a product information from said second computer, said product information defining the circuit-board inspection apparatus or the component of circuit-board inspection apparatuses which is prepared for said board-specification information and is providable from said first dealer; and
means for providing said received product information to said first computer.

2. An information service system as defined in claim 1, wherein said third computer includes:
means for receiving an order of the circuit-board inspection apparatus or the component of circuit-board inspection apparatuses from said first computer, said circuit-board inspection apparatus or the component being selected by said client according to said product information; and
means for notifying the receipt of said order to said second computer according to the content of said received order.

3. An information service system as defined in claim 1, wherein said second computer is available for a second dealer intending to provide an after-sale service of circuit-board inspection apparatuses or components of circuit-board inspection apparatuses, wherein said third computer includes:
means for receiving a demand of said client for an after-sale service from said first computer, said after-sale service relating to said circuit-board inspection apparatus or said component of inspection apparatuses which has been purchased by said client from said first dealer; and
means for notifying said received demand to said second computer available for said first dealer who has sold said circuit-board inspection apparatus or said component of circuit-board inspection apparatuses, or for said second dealer intending to provide said after-sale service.

4. An information service system as defined in claim 1, wherein said third computer includes:
means for receiving from said first computer at least either one of a desired delivery date of the circuit-board inspection apparatus, a desired cost of the circuit-board inspection apparatus, and an equipment information defining a circuit-board inspection equipment owned by said client; and
means for providing the product information prepared for said delivery date, said cost and said equipment information to said first computer.

5. An information service system as defined in claim 1, wherein said third computer includes a dealer database storing a dealer information defined for each of said dealers.

6. An information service system as defined in claim 5, wherein said dealer information includes a contact address, size, transaction record, product list and trouble in transaction of each of said dealers.

7. An information service system as defined in claim 1, wherein said third computer includes a client database storing a client information defining said client.

8. An information service system as defined in claim 7, wherein said client information includes a contact address, request history, content of equipment owned by said client, and troubles in dealing of said client.

9. An information service system as defined in claim 1, wherein said third computer provides the board-specification information to said second computer available for said first dealer according to said received board-specification information, said first dealer handling the circuit-board inspection apparatus or the component of circuit-board inspection apparatuses which is suitable for inspecting said circuit board.

10. An information service system as defined in claim 1, wherein said third computer includes:
means for producing a management table for said request when said board-specification information is received; and
means for storing said management table in association with said board-specification information.

11. An information service apparatus capable of communicating with a first computer and a second computer via a communication line, said first computer being available for a client intending to make a request for supplying an inspection apparatus used for a circuit board, said second computer being available for a dealer intending to provide a circuit-board inspection apparatus or a component of circuit-board inspection apparatuses, wherein said information service apparatus is adapted to receive said request from said first computer, said information service apparatus comprising:
means for receiving a board-specification information defining a specification of said circuit board from said first computer;
means for providing said received board-specification information to said second computer;
means for receiving a product information from said second computer, said product information defining the circuit-board inspection apparatus or the component of circuit-board inspection apparatuses which is prepared for said board-specification information and is providable from said dealer; and
means for providing said received product information to said first computer.

12. An information acquisition apparatus capable of communicating with a first computer via a communication line, said first computer being capable of communicating with a second computer via a communication line and receiving a request for supplying an inspection apparatus used for a circuit board, said second computer being available for a dealer intending to provide a circuit-board inspection apparatus or a component of circuit-board inspection apparatuses, said information acquisition apparatus comprising:
means for providing a request for supplying an inspection apparatus used for a circuit board, and a board-specification information defining a specification of said circuit board to said first computer; and
means for acquiring from said first computer a product information provided from said second computer to said first computer, said product information defining the circuit-board inspection apparatus or the component. of circuit-board inspection apparatuses which is prepared for said board-specification information and is providable from said dealer.

13. An information service apparatus capable of communicating with a first computer via a communication line, said first computer being capable of communicating via a communication line with a second computer available for a client intending to make a request for supplying an inspection apparatus used for a circuit board, said first computer being adapted to receive said request from said second computer, said information service apparatus comprising:
means for acquiring from said first computer a board-specification information provided from said second computer to said first computer, said board-specification information defining a specification of said circuit board related to said request; and
means for providing a product information to said first computer, said product information defining the circuit-board inspection apparatus or the component of circuit-board inspection apparatuses which is prepared for said board-specification information.

14. An information service method for providing information about an inspection apparatus to a client making a request for supplying an inspection apparatus used for a circuit board, said information service method comprising the steps of:
receiving from said client a board-specification information defining a specification of said circuit board;
providing said received board-specification information to a dealer intending to provide a circuit-board inspection apparatus or a component of circuit-board inspection apparatuses;
receiving a product information defining the circuit-board inspection apparatus or the component of circuit-board inspection apparatuses which is prepared for said board-specification information and is providable from said dealer; and
providing said received product information to said client.

15. A recording medium on which is recorded a program allowing a first computer to function as specific means, said first computer being capable of communicating with a second computer and a third computer via a communication line, said second computer being available for a client intending to make a request for supplying an inspection apparatus used for a circuit board, said third computer available for a dealer intending to provide a circuit-board inspection apparatus or a component of circuit-board inspection apparatuses, said first computer being adapted to receive said request from said second computer, said specific means including:
means for receiving a board-specification information defining a specification of said circuit board from said second computer;
means for providing said received board-specification information to said third computer;
means for receiving a product information from said third computer, said product information defining the circuit-board inspection apparatus or the component of circuit-board inspection apparatuses which is prepared for said board-specification information and is providable from said dealer; and
means for providing said received product information to said second computer.

16. A recording medium on which is recorded a program allowing a first computer to function as specific means, said first computer being capable of communicating with a second computer via a communication line, said second computer being capable of communicating with a third computer via a communication line and receiving a request for supplying an inspection apparatus used for a circuit board, said third computer being available for a dealer intending to provide a circuit-board inspection apparatus or a component of circuit-board inspection apparatuses, said specific means including:
means for providing a request for supplying an inspection apparatus used for a circuit board, and a board-specification information defining a specification of said circuit board to said second computer; and
means for acquiring from said second computer a product information provided from said third computer to said second computer, said product information defining the circuit-board inspection apparatus or the component of circuit-board inspection apparatuses which is prepared for said board-specification information and is providable from said dealer.

17. A recording medium on which is recorded a program allowing a first computer to function as specific means, said first computer being capable of communicating with a second computer via a communication line, said second computer being capable of communicating via a communication line with a third computer available for a client intending to make a request for supplying an inspection apparatus used for a circuit board, said second computer being adapted to receive said request from said third computer, said specific means including:
means for acquiring from said second computer a board-specification information provided from said third computer to said second computer, said board-specification information defining a specification of said circuit board related to said request; and
means for providing a product information to said second computer, said product information defining the circuit-board inspection apparatus or the component of circuit-board inspection apparatuses which is prepared for said board-specification information.

18. An information service system comprising:
a first computer available for a client intending to make a request for a manufacturing service of a circuit board;
a second computer available for a dealer intending to provide a circuit-board manufacturing service; and
a third computer capable of communicating with said first computer and said second computer via a communication line, said third computer being adapted to receive said request from said first computer, wherein
said third computer including:
means for receiving a board-specification information defining a specification of said circuit board from said first computer;
means for providing said received board-specification information to said second computer;
means for receiving a product information from said second computer, said product information being related to the circuit board which is prepared for said board-specification information and is providable from said first dealer; and
means for providing said received product information to said first computer.

19. An information service system as defined in claim 18, wherein said product information includes at least either one of a cost, delivery-date and available number for sale of said circuit board.

20. An information service apparatus capable of communicating with a first computer and a second computer via a communication line, said first computer being available for a client intending to make a request for a manufacturing service of a circuit board, said second computer being available for a dealer intending to provide a circuit-board manufacturing service, wherein said information service apparatus is adapted to receive said request from said first computer, said information service apparatus comprising:
means for receiving a board-specification information defining a specification of said circuit board from said first computer;
means for providing said received board-specification information to said second computer;
means for receiving a product information from said second computer, said product information being related to the circuit board which is prepared for said board-specification information and is providable from said dealer; and
means for providing said received product information to said first computer.

21. An information acquisition apparatus capable of communicating with a first computer via a communication line, said first computer being capable of communicating with a second computer via a communication line and receiving a request for a manufacturing service of a circuit board, said second computer being available for a dealer intending to provide a circuit-board manufacturing service, said information acquisition apparatus comprising:
means for providing a request for a manufacturing service of a circuit board, and a board-specification information defining a specification of said circuit board to said first computer; and
means for acquiring from said first computer a product information provided from said second computer to said first computer, said product information being related to the circuit board which is prepared for said board-specification information and is providable from said dealer.

22. An information service apparatus capable of communicating with a first computer via a communication line, said first computer being capable of communicating via a communication line with a second computer available for a client intending to make a request for a manufacturing service of a circuit board, said first computer being adapted to receive said request from said second computer, said information service apparatus comprising:
means for acquiring from said first computer a board-specification information provided from said second computer to said first computer, said board-specification information defining a specification of said circuit board related to said request; and
means for providing a product information to said first computer, said product information being related to the circuit board which is prepared for said board-specification information.

23. An information service method for providing information about a circuit-board manufacturing service to a client making a request for a manufacturing service of a circuit board, said information service method comprising the steps of:
receiving from said client a board-specification information defining a specification of said circuit board;
providing said received board-specification information to a dealer intending to provide a circuit-board manufacturing service;
receiving a product information related to the circuit board which is prepared for said board-specification information and is providable from said dealer; and
providing said received product information to said client.

24. A recording medium on which is recorded a program allowing a first computer to function as specific means, said first computer being capable of communicating with a second computer and a third computer via a communication line, said second computer being available for a client intending to make a request for a manufacturing service of a circuit board, said third computer available for a dealer intending to provide a circuit-board manufacturing service, said first computer being adapted to receive said request from said second computer, said specific means including:
means for receiving a board-specification information defining a specification of said circuit board from said second computer;
means for providing said received board-specification information to said third computer;
means for receiving a product information from said third computer, said product information being related to the circuit board which is prepared for said board-specification information and is providable from said dealer; and
means for providing said received product information to said second computer.

25. A recording medium on which is recorded a program allowing a first computer to function as specific means, said first computer being capable of communicating with a second computer via a communication line, said second computer being capable of communicating with a third computer via a communication line and receiving a request for a manufacturing service of a circuit board, said third computer being available for a dealer intending to provide a circuit-board manufacturing service, said specific means including:
means for providing a request for a manufacturing service of a circuit board, and a board-specification information defining a specification of said circuit board to said second computer; and
means for acquiring from said second computer a product information provided from said third computer to said second computer, said product information being related to the circuit board which is prepared for said board-specification information and is providable from said dealer.

26. A recording medium on which is recorded a program allowing a first computer to function as specific means, said first computer being capable of communicating with a second computer via a communication line, said second computer being capable of communicating via a communication line with a third computer available for a client intending to make a request for a manufacturing service of a circuit board, said second computer being adapted to receive said request from said third computer, said specific means including:
means for acquiring from said second computer a board-specification information provided from said third computer to said second computer, said board-specification information defining a specification of said circuit board related to said request; and
means for providing a product information to said second computer, said product information being related to the circuit board which is prepared for said board-specification information.

27. An information service system comprising:
a first computer available for a client intending to make a request for an inspection service of a circuit board;
a second computer available for a dealer intending to provide a circuit-board inspection service; and
a third computer capable of communicating with said first computer and said second computer via a communication line, said third computer being adapted to receive said request from said first computer, wherein
said third computer including:
means for receiving a board-specification information defining a specification of said circuit board from said first computer;
means for providing said received board-specification information to said second computer;
means for receiving a service information from said second computer, said service information defining the circuit-board inspection which is prepared for said board-specification information and is practicable by said first dealer; and
means for providing said received service information to said first computer.

28. An information service system as defined in claim 27, wherein said service information includes at least either one of an inspection cost and inspection time-schedule.

29. An information service apparatus capable of communicating with a first computer and a second computer via a communication line, said first computer being available for a client intending to make a request for an inspection service of a circuit board, said second computer being available for a dealer intending to provide a circuit-board inspection service, wherein said information service apparatus is adapted to receive said request from said first computer, said information service apparatus comprising:
means for receiving a board-specification information defining a specification of said circuit board from said first computer;
means for providing said received board-specification information to said second computer;
means for receiving a service information from said second computer, said service information defining the circuit-board inspection which is prepared for said board-specification information and is practicable by said dealer; and
means for providing said received service information to said first computer.

30. An information acquisition apparatus capable of communicating with a first computer via a communication line, said first computer being capable of communicating with a second computer via a communication line and receiving a request for an inspection service of a circuit board, said second computer being available for a dealer intending to provide a circuit-board inspection service, said information acquisition apparatus comprising:
means for providing a request for an inspection service of a circuit board, and a board-specification information defining a specification of said circuit board to said first computer; and
means for acquiring from said first computer a service information provided from said second computer to said first computer, said service information defining the circuit-board inspection which is prepared for said board-specification information and is practicable by said dealer.

31. An information service apparatus capable of communicating with a first computer via a communication line, said first computer being capable of communicating via a communication line with a second computer available for a client intending to make a request for an inspection service of a circuit board, said first computer being adapted to receive said request from said second computer, said information service apparatus comprising:
means for acquiring from said first computer a board-specification information provided from said second computer to said first computer, said board-specification information defining a specification of said circuit board related to said request; and
means for providing a service information to said first computer, said product information defining the circuit-board inspection which is prepared for said board-specification information.

32. An information service method for providing information about a circuit-board inspection service to a client making a request for an inspection service of a circuit board, said information service method comprising the steps of:
receiving from said client a board-specification information defining a specification of said circuit board;
providing said received board-specification information to a dealer intending to provide a circuit-board inspection service;
receiving a service information defining the circuit-board inspection which is practicable by said dealer; and
providing said received service information to said client.

33. A recording medium on which is recorded a program allowing a first computer to function as specific means, said first computer being capable of communicating with a second computer and a third computer via a communication line, said second computer being available for a client intending to make a request for an inspection service of a circuit board, said third computer available for a dealer intending to provide a circuit-board inspection service, said first computer being adapted to receive said request from said second computer, said specific means including:
means for receiving a board-specification information defining a specification of said circuit board from said second computer;
means for providing said received board-specification information to said third computer;
means for receiving a service information from said third computer, said service information defining the circuit-board inspection which is prepared for said board-specification information and is practicable by said dealer; and
means for providing said received service information to said second computer.

34. A recording medium on which is recorded a program allowing a first computer to function as specific means, said first computer being capable of communicating with a second computer via a communication line, said second computer being capable of communicating with a third computer via a communication line and receiving a request for an inspection service of a circuit board, said third computer being available for a dealer intending to provide a circuit-board inspection service, said specific means including:
means for providing a request for an inspection service of a circuit board, and a board-specification information defining a specification of said circuit board to said second computer; and
means for acquiring from said second computer a service information provided from said third computer to said second computer, said service information defining the circuit-board inspection which is prepared for said board-specification information and is practicable by said dealer.

35. A recording medium on which is recorded a program allowing a first computer to function as specific means, said first computer being capable of communicating with a second computer via a communication line, said second computer being capable of communicating via a communication line with a third computer available for a client intending to make a request for an inspection service of a circuit board, said second computer being adapted to receive said request from said third computer, said specific means including:
means for acquiring from said second computer a board-specification information provided from said third computer to said second computer, said board-specification information defining a specification of said circuit board related to said request; and
means for providing a service information to said second computer, said service information defining the circuit-board inspection which is prepared for said board-specification information.

36. An information service apparatus capable of communicating with a first computer available for a client intending to make a request for supplying an inspection apparatus used for a circuit board, wherein said information service apparatus is adapted to receive said request from said first computer, said information service apparatus comprising:
means for receiving a board-specification information defining a specification of said circuit board from said first computer; and
means for providing a product information to said first computer, said product information being collected from a dealer intending to provide a circuit-board inspection apparatus or a component of circuit-board inspection apparatuses, said product information defining the circuit-board inspection apparatus or the component of circuit-board inspection apparatuses which is prepared for said received board-specification information.

37. An information service apparatus capable of communicating with a first computer available for a client intending to make a request for a manufacturing service of a circuit board, wherein said information service apparatus is adapted to receive said request from said first computer, said information service apparatus comprising:
means for receiving a board-specification information defining a specification of said circuit board from said first computer; and
means for providing a product information to said first computer, said product information being collected from a dealer intending to provide a circuit-board manufacturing service, said product information being related to the circuit board which is prepared for said received board-specification information.

38. An information service apparatus capable of communicating with a first computer available for a client intending to make a request for supplying an inspection service of a circuit board, wherein said information service apparatus is adapted to receive said request from said first computer, said information service apparatus comprising:
means for receiving a board-specification information defining a specification of said circuit board from said first computer; and
means for providing a service information to said first computer, said service information being collected from a dealer intending to provide a circuit-board inspection service, said product information defining the circuit-board inspection which is prepared for said received board-specification information and is practicable by said dealer.
